(19) United States
(12) Patent Application Publication
(10) Pub. No.: US 2009/0194247 A1
(43) Pub. Date: Aug. 6, 2009

(54) Method for repair of a metallic hollow body

(75) Inventor: Bernd Kriegl, Olching (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/322,484

(22) Filed: Feb. 3, 2009

(30) Foreign Application Priority Data
Feb. 5, 2008 (DE) 10 2008 007 820.4

(51) Int. Cl. B23P 6/00; B23K 31/02

(52) U.S. Cl. 164/76.1; 228/119; 29/889.1; 29/402.11; 29/402.13

(57) ABSTRACT

A method for repairing a metallic hollow body including at least one damaged portion to be repaired in a wall enclosing at least one cavity of the hollow body, the wall being a metallic material, is provided. The method includes the steps of filling a settable filling compound into at least one partial area of the at least one cavity; setting the filling compound; removing a predefined partial surface of the wall in an area of the at least one damaged portion; sealing the wall in an area of the removed partial surface by producing a covering element by welding, soldering, or casting-on; and removing the filling compound.

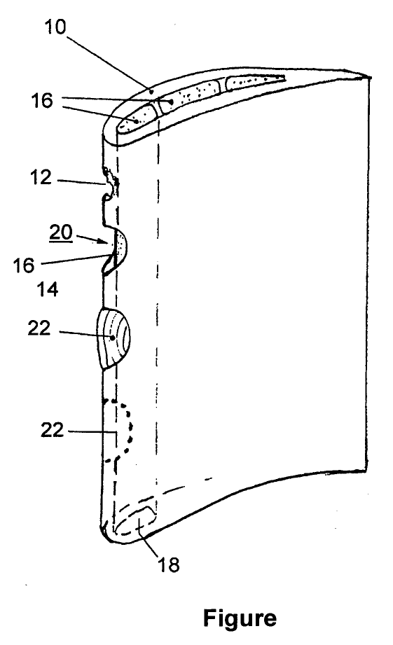

Priority is claimed to German Patent Application DE 10 2008 007 820.4, filed Feb. 5, 2008, which is incorporated by reference herein.

The present invention relates to a method for repairing a metallic hollow body, in particular a component of a gas turbine or an aircraft engine. The present invention further relates to a component of a gas turbine or an aircraft engine repaired using said method.

### BACKGROUND

The repair of a metallic hollow body, in particular of a component of a gas turbine or an aircraft engine, is often associated with a very high material expenditure. Furthermore, for example, welding and soldering repairs of cracks on cooled blades and vanes of turbines are allowed only to a limited extent, as far as their component strength, geometry, and accessibility allow appropriate repairs. Major damage to such metallic hollow bodies must be repaired using so-called patches or cast replacement parts if a repair of this type is possible at all. Complex single-crystal cast replacement parts are difficult and expensive to procure; in addition, the repair procedure is complex and extremely inflexible if the replacement part does not fit the damage patterns. Repair of metallic hollow bodies, in particular of a component of a gas turbine or an aircraft engine, has been possible only at a high cost if possible at all.

### SUMMARY OF THE INVENTION

It is therefore an object of the present invention to provide a method of the above-mentioned generic type for repairing a metallic hollow body, in particular a component of a gas turbine or an aircraft engine, in which cost-effective repair of the hollow body is possible even at hard-to-access or inaccessible places having a complex internal geometry.

It is furthermore an object of the present invention to provide a component of the above-mentioned type in which a cost-effective repair is possible even at hard-to-access or inaccessible places of a hollow component.

These objects may be achieved by a method according to the present invention.

The method of the present invention for repairing a metallic hollow body, in particular a component of a gas turbine or an aircraft engine, includes the following steps:
a) providing a hollow body to be repaired, having at least one damage to be repaired in a wall enclosing at least one cavity of the hollow body;
b) filling a settable filling compound in at least one partial area of the cavity having the damage in the wall;
c) setting the filling compound;
d) removing a predefined partial surface of the wall in the area of the damage;
e) sealing the wall in the area of the removed partial surface by producing a covering element by welding, soldering, or casting-on, the metallic material of the covering element being identical or similar to the metallic material of the wall; and
f) removing the filling compound.

Embodiments of the method according to the present invention make it possible, for example, to make welding repairs at places on hollow bodies which are not accessible from the inside for machining, but are absolutely necessary for restoring the new part's geometry. Embodiments of the method according to the present invention make cost-effective repair of hollow bodies possible even at difficult-to-access or inaccessible places having a complex internal geometry. Further advantages result due to the fact that no finishing work is necessary inside the hollow body. Replacement parts having a predefined geometry are not necessary, so that the method according to the present invention may be used on a plurality of damage patterns. Another advantage of embodiments of the method according to the present invention is that no contamination of the inside of the hollow body occurs due to certain operations.

In advantageous embodiments of the method according to the present invention, the filling compound is made of a ceramic powder preparation, at least one liquid being added. The filling compound may contain aluminum oxides and/or aluminum silicates, zirconium silicates and/or zirconium oxides, silicon dioxide, silicon carbide, yttrium oxides and/or yttrium silicates, rare earth oxides and/or rare earth silicates, and/or organic and/or inorganic binders and/or surfactants and/or viscosity-modifying agents. The liquid may be any liquid which may be mixed with the powdery solids and produces a fluid mass. It may be, for example, water, oils, alcohols, and the like. The fluid filling compound is introduced according to method step b) using a casting or injection process. In a preferred embodiment of the method according to the present invention, the filling compound filled into the cavities of the hollow body is set according to method step c) by a heat treatment of the filling compound. In particular, the filling compound is sintered. The sintering time and temperature may be set in such a way that the filling compound sets, but may be easily removed again in method step f). The heat treatment imparts ceramic-like properties to the filling compound.

In another advantageous embodiment of the method according to the present invention, an exposed surface of the filling compound is subjected to a finishing operation after method step d). The finishing operation may be performed, for example, as a grinding operation. In the event of visible damage, for example, this advantageously makes it possible to produce a desired original internal geometry of the hollow body.

In further advantageous embodiments of the method according to the present invention, the wall is sealed according to method step e) with the aid of a hard-soldering method and/or a welding method, using suitable additives. Such sealing with the aid of a hard-soldering method and/or a welding method becomes possible due to the method according to the present invention even at places of hollow bodies which are inaccessible for machining from the inside.

In further advantageous embodiments of the method according to the present invention, the filling compound is removed with the aid of a chemical leaching process. Concentrated sodium hydroxide or potassium hydroxide solutions, which are additionally heated, may be used, for example, for leaching out the filling compound. In particular, leaching may be performed in an autoclave under high pressure. The leaching process requires less than 12 hours, since the setting or sintering of the filling compound may be controlled via the temperature and time of a heat treatment in such a way that a chemical attack on the set filling compound is possible within the said time frame. In addition to chemical leaching, other, for example, mechanical or physical methods are conceivable for removing the filling compound.

In other advantageous embodiments of the method according to the present invention, a finishing operation of the cover element is performed immediately after method step f). The finishing operation may be performed, for example, with the aid of a grinding and/or cutting operation, in particular of an adaptive cutting operation. Other methods for finishing the repaired hollow body or the cover element are also conceivable. By finishing the repaired location from the outside, it may be easily adapted to the geometry of a new part.

In another advantageous embodiment of the method according to the present invention, the hollow body to be repaired is cleaned prior to being readied. Thus, in particular the cavities of the hollow body into which the filling compound is to be cast are advantageously prepared optimally for the filling operation.

In an advantageous embodiment of the method according to the present invention, the hollow body is a cooled blade or vane of a turbine.

A component of a gas turbine or an aircraft engine according to the present invention is repaired according to the above-described method. The component may be a cooled blade or vane of a turbine.

### BRIEF DESCRIPTION OF THE DRAWING

Further advantages, features, and details of the present invention are derived from the following description of an exemplary embodiment illustrated in the drawing.

The FIGURE shows the method according to the present invention in a specific embodiment of the hollow body.

### DETAILED DESCRIPTION

Hollow body 10 is a blade of a gas turbine in the exemplary embodiment illustrated here. It is apparent that blade 10 has cavities 18, which have been filled, at least partially, with a filling compound 16. Set filling compound 16 has ceramic properties. It is apparent that blade 10 has a damage 12 in the uppermost left area of the FIGURE. Damage 12 is a rupture or a crack which was produced by a certain stress in this area. Other types of damage are also conceivable, for example damage that may occur due to the effect of oxidation. The illustration shows, as an example, the removal of a predefined partial surface 20 of a wall 14 beneath this damage 12. Partial surface 20 is to be removed in the area of damage 12; for graphical reasons, the drawing represents the individual method steps underneath each other on the same blade 10.

Furthermore, it is apparent that after the removal of partial surface 20, wall 14 is sealed in the area of removed partial surface 20 by appending and joining a covering element 22. The metallic material of covering element 22 is similar or identical to the metallic material of wall 14. Wall 14 may be sealed using a hard soldering method and/or a welding method or by local casting-on, using appropriate additives. In a final method step, the finishing operation of covering element 22 is illustrated. It is apparent that this finishing operation has adapted the repaired location of blade 10 or of covering element 22 to the required component geometry in this area. The finishing operation may be performed, for example, as a grinding or cutting operation, in particular an adaptive cutting operation. The finishing operation may be performed immediately before or after the removal of filling compound 16. Blade 10 having filling compound 16 removed is schematically illustrated in the lower left area of the FIGURE.

According to the illustrated exemplary embodiment, filling compound 16 is removed with the aid of a chemical leaching process.

What is claimed is:

1. A method for repairing a metallic hollow body including at least one damaged portion to be repaired in a wall enclosing at least one cavity of the hollow body, the wall being a metallic material, the method comprising the steps of:
filling a settable filling compound into at least one partial area of the at least one cavity;
setting the filling compound;
removing a predefined partial surface of the wall in an area of the at least one damaged portion;
sealing the wall in an area of the removed partial surface by producing a covering element by welding, soldering, or casting-on; and
removing the filling compound.

2. The method as recited in claim 1 wherein the covering element is a metallic material similar to the metallic material of the wall.

3. The method as recited in claim 1 wherein the covering element is a metallic material identical to the metallic material of the wall.

4. The method as recited in claim 1 wherein the filling compound is made by adding at least one liquid to a ceramic powder preparation.

5. The method as recited in claim 4 wherein the filling compound contains aluminum oxides and/or aluminum silicates, zirconium silicates and/or zirconium oxides, silicon dioxide, silicon carbide, yttrium oxides and/or yttrium silicates, rare earth oxides and/or rare earth silicates, and/or organic and/or inorganic binders and/or surfactants and/or viscosity-modifying agents.

6. The method as recited in claim 1 wherein the filling compound is filled into the at least one partial area of the at least one cavity with the aid of a casting or injection operation.

7. The method as recited in claim 1 wherein the setting of the filling compound is performed by heat treating the filling compound.

8. The method as recited in claim 5 wherein the heat treating is performed by sintering.

9. The method as recited in claim 1 wherein a surface of the filling compound is exposed after the predefined partial surface of the wall is removed, the exposed surface of the filling compound being subjected to a finishing operation before the wall is sealed in an area of the removed partial surface.

10. The method as recited in claim 9 wherein the finishing operation is performed by a grinding operation.

11. The method as recited in claim 1 wherein the wall is sealed in an area of the removed partial surface with the aid of a hard-soldering method, using suitable additives.

12. The method as recited in claim 1 wherein the wall is sealed in an area of the removed partial surface with the aid of a welding method, using suitable additives.

13. The method as recited in claim 1 wherein the wall is sealed in an area of the removed partial surface with the aid of a hard-soldering method and a welding method, using suitable additives.

14. The method as recited in claim 1 wherein the filling compound is removed with the aid of a chemical leaching process.

15. The method as recited in claim 14 wherein concentrated sodium hydroxide solutions are used in the chemical leaching process.

16. The method as recited in claim 14 wherein concentrated potassium hydroxide solutions are used in the chemical leaching process.

17. The method as recited in claim 14 wherein the chemical leaching process is performed in an autoclave under high pressure.

18. The method as recited in claim 1 wherein the covering element is subjected to a finishing operation immediately before the filling compound is removed.

19. The method as recited in claim 18 wherein the finishing operation is performed by a grinding operation.

20. The method as recited in claim 18 wherein the finishing operation is performed by a cutting operation.

21. The method as recited in claim 18 wherein the finishing operation is performed by a grinding and cutting operation.

22. The method as recited in claim 1 wherein the hollow body is cleaned before the filling compound is filled into the at least one partial area of the at least one cavity.
